(19) United States
(12) Patent Application Publication
(10) Pub. No.: US 2026/0370168 A1
(43) Pub. Date: Nov. 19, 2026

(54) SYNCHRONOUS MACHINE CONTROL DEVICE

(71) Applicant: Astemo, Ltd., Chiyoda-ku, Tokyo (JP)

(72) Inventors: Kentaro MATSUO, Hitachinaka-shi, Ibaraki (JP); Shun TANIGUCHI, Tokyo (JP)

(73) Assignee: Astemo, Ltd., Chiyoda-ku, Tokyo (JP)

(21) Appl. No.: 19/158,799

(22) PCT Filed: Feb. 22, 2023
(86) PCT No.: PCT/JP2023/006578

§ 371 Date: Aug. 21, 2025

(51) Int. Cl. H02P 21/14; H02P 21/22

(52) U.S. Cl. CPC H02P 21/141; H02P 21/22; H02P 2207/05

(57) ABSTRACT

An object of the present invention is to provide a synchronous machine control device which suppresses an overcurrent and a torque fluctuation when a three-phase open mode or a short-circuit mode is switched to a torque mode (PWM mode). In order to solve the above problem, a synchronous machine control device according to the present invention is a synchronous machine control device which controls a power converter which supplies power to a synchronous machine, the synchronous machine control device including: a first magnetic flux command calculation unit which calculates a first magnetic flux command value from a current command value of the synchronous machine; a magnetic flux estimation unit that estimates a magnetic flux value of the synchronous machine from a current detection value of the synchronous machine; and a second magnetic flux command calculation unit which uses an integration controller to calculate a second magnetic flux command value such that the first magnetic flux command value and the magnetic flux value match. When the power converter is switched from a three-phase short circuit to a PWM control, the integration controller on the d-axis side is initialized to a d-axis magnetic flux value, and the integration controller on the q-axis side is initialized to a q-axis magnetic flux value.

### TECHNICAL FIELD

The present invention relates to a synchronous machine control device for driving a synchronous machine such as a synchronous motor.

### BACKGROUND ART

In order to miniaturize a synchronous motor, performance improvement such as high-speed rotation and high magnetic flux density of the motor is in progress. In particular, in an electric vehicle such as an electric car, the tendency is remarkable since the weight of the motor affects a power consumption amount.

As a control device capable of improving the performance of the motor, a control device described in PTL 1 is known. The control device described in PTL 1 calculates a first magnetic flux command value from a current command value of the synchronous machine, estimates a magnetic flux value of the synchronous machine from a current detection value of the synchronous machine, and generates a voltage command value of a power converter such that the first magnetic flux command value and the magnetic flux value match.

### CITATION LIST

### Patent Literature

PTL 1: JP 2021-151003 A

### SUMMARY OF INVENTION

### Technical Problem

In the control device described in PTL 1, in a PI controller which calculates a second d-axis magnetic flux command value, a difference between a first d-axis magnetic flux command value and a d-axis magnetic flux estimation value is calculated by an adder-subtractor. In addition, a difference calculation value is integrated by an integrator, and an integral value is multiplied by an integral gain (KI). An adder 99 adds the difference calculation value multiplied by a proportional gain 97 and the integral value multiplied by the integral gain to calculate the second d-axis magnetic flux command value. In addition, a second q-axis magnetic flux command value is similarly calculated.

At this time, when a power conversion device is switched from a three-phase open mode or a short-circuit mode to a torque mode (PWM mode), if an initial value of the integrator is incorrect, a difference may occur between an output voltage of the power conversion device and a voltage of the synchronous machine at the time of switching to the PWM mode, and an overcurrent, a torque fluctuation, or the like may occur.

The present invention has been made in view of such problems, and an object of the present invention is to provide a synchronous machine control device which suppresses an overcurrent and a torque fluctuation when a three-phase open mode or a short-circuit mode is switched to a torque mode (PWM mode).

### Solution to Problem

In order to solve the above problem, a synchronous machine control device according to the present invention is a synchronous machine control device which controls a power converter which supplies power to a synchronous machine, the synchronous machine control device including: a first magnetic flux command calculation unit which calculates a first magnetic flux command value from a current command value of the synchronous machine; a magnetic flux estimation unit that estimates a magnetic flux value of the synchronous machine from a current detection value of the synchronous machine; and a second magnetic flux command calculation unit which uses an integration controller to calculate a second magnetic flux command value such that the first magnetic flux command value and the magnetic flux value match. When the power converter is switched from a three-phase short circuit to a PWM control, the integration controller on the d-axis side is initialized to a d-axis magnetic flux value, and the integration controller on the q-axis side is initialized to a q-axis magnetic flux value.

### Advantageous Effects of Invention

According to the present invention, it is possible to suppress the overcurrent and the torque fluctuation when the three-phase open mode or the short-circuit mode is switched to the torque mode (PWM mode).

Problems, configurations, and effects other than those described above will be clarified by the following description of embodiments.

### BRIEF DESCRIPTION OF DRAWINGS

FIG. 1 is a block diagram illustrating a functional configuration of a synchronous machine control device according to an embodiment.

FIG. 2 is a block diagram illustrating a functional configuration of a PI controller in a second dq-axis magnetic flux command calculation unit 25.

FIG. 3 illustrates a configuration of a voltage vector calculation unit 19 configured based on an inverse model expressed by Expression (1).

FIG. 4 illustrates an example of a relationship between a magnetic flux and a current.

FIG. 5 is a block diagram illustrating a configuration of an integrator according to an embodiment.

FIG. 6 is a block diagram illustrating a configuration of an integrator according to a modification of the embodiment.

FIG. 7 is a diagram illustrating a current waveform at a time of switching from a three-phase short circuit to a PWM mode in a conventional control.

FIG. 8 is a diagram illustrating a current waveform at the time of switching from the three-phase short circuit to the PWM mode in a control according to the embodiment.

FIG. 9 is a diagram illustrating a current waveform at a time of switching from a three-phase open mode to the PWM mode in the conventional control.

FIG. 10 is a diagram illustrating a current waveform at the time of switching from the three-phase open mode to the PWM mode in the control according to the embodiment.

### DESCRIPTION OF EMBODIMENTS

Hereinafter, an embodiment of the present invention will be described with reference to the drawings. In the drawings, the same reference numerals indicate the same components or components having similar functions.

In the following description, a synchronous machine to be controlled is a permanent magnet synchronous motor (hereinafter, referred to as “PMSM” (abbreviation of Permanent Magnet Synchronous Motor)).

### [Overall Configuration]

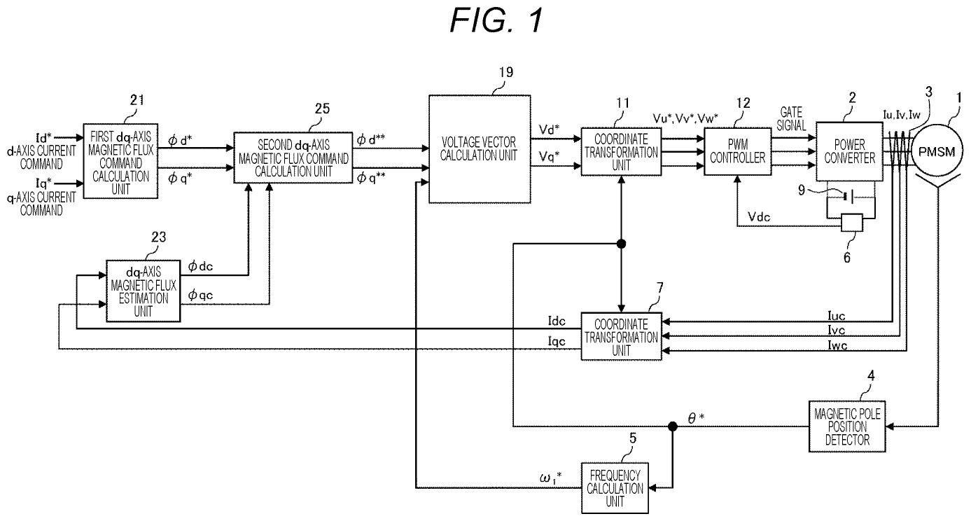

FIG. 1 is a block diagram illustrating a functional configuration of a synchronous machine control device according to the present embodiment. Note that in the present embodiment, a computer system such as a microcomputer executes a predetermined program to function as the synchronous machine control device illustrated in FIG. 1.

In FIG. 1, a power converter 2 converts DC power from a DC voltage source 9 (for example, a battery) into AC power and outputs the AC power to a PMSM 1. The PMSM 1 is rotationally driven by the AC power. The power converter 2 includes an inverter main circuit including a semiconductor switching element. The semiconductor switching element is controlled by a gate signal to be turned on and off, whereby the DC power is converted into the AC power. Note that as the semiconductor switching element, for example, an insulated gate bipolar transistor (IGBT) is applied.

A phase current detector 3 detects three-phase motor currents flowing from the power converter 2 to the PMSM 1, that is, a U-phase current Iu, a V-phase current Iv, and a W-phase current Iw, and outputs them as a U-phase current detection value Iuc, a V-phase current detection value Ivc, and a W-phase current detection value Iwc, respectively. Note that as the phase current detector 3, a Hall current transformer (CT) or the like is applied.

A magnetic pole position detector 4 detects a magnetic pole position of the PMSM 1 and outputs magnetic pole position information θ*. A resolver or the like is applied as the magnetic pole position detector 4.

A frequency calculation unit 5 calculates, from the magnetic pole position information θ* output from the magnetic pole position detector 4, speed information ω₁* by time differentiation calculation or the like, and outputs speed information ω₁*.

A coordinate transformation unit 7 transforms Iuc, Ivc, and Iwc output from the phase current detector into dq-axis current detection values Idc and Iqc in a rotating coordinate system according to the magnetic pole position information θ*, and outputs Idc and Iqc.

A dq-axis magnetic flux estimation unit 23 refers to a lookup table (table data) based on the dq-axis current detection values Idc and Iqc output from the coordinate transformation unit 7 to estimate the dq-axis magnetic flux estimation values φdc and φqc. The lookup table (table data) referred to by the dq-axis magnetic flux estimation unit 23 is table data representing correspondence between Idc and Iqc and φdc and φqc, and is stored in a storage device (not illustrated) included in the synchronous machine control device of the present embodiment. Note that a predetermined function (approximate expression or the like) may be used instead of the lookup table.

A first dq-axis magnetic flux command calculation unit 21 refers to a lookup table (table data) based on dq-axis current command values Idc* and Iqc* provided from a host control device or the like to calculate and output first dq-axis magnetic flux command values φd* and φq*. The lookup table (table data) referred to by the first dq-axis magnetic flux command calculation unit 21 is table data representing correspondence between Idc* and Iqc* and φd* and φq*, and is stored in a storage device (not illustrated) included in the synchronous machine control device of the present embodiment. Note that a predetermined function (approximate expression or the like) may be used instead of the lookup table.

A second dq-axis magnetic flux command calculation unit 25 calculates and outputs a second dq-axis magnetic flux command values φd** and φq** by a proportional integral (PI) controller such that the first dq-axis magnetic flux command values φd* and φq* and the dq-axis magnetic flux estimation values φdc and φqc match with each other.

### [PI Controller]

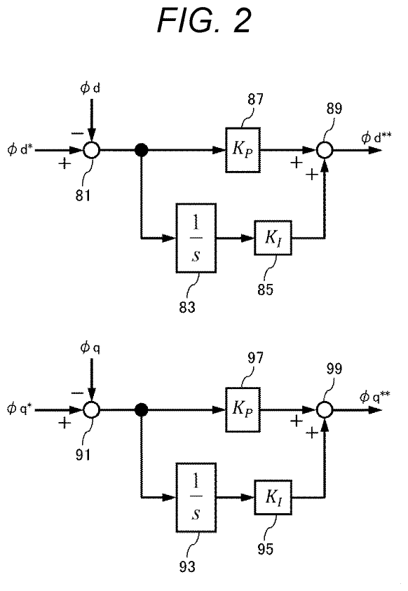

FIG. 2 is a block diagram illustrating a functional configuration of a PI controller in the second dq-axis magnetic flux command calculation unit 25.

As illustrated in the upper diagram of FIG. 2, in the PI controller which calculates the second d-axis magnetic flux command value φd**, an adder-subtractor 81 calculates a difference (φd*−φdc) between the first d-axis magnetic flux command value od* and the d-axis magnetic flux estimation value φdc, and multiplies the difference calculation value by a proportional gain 87 (K_{P}). In addition, the difference calculation value is integrated by an integrator 83, and the integral value is multiplied by an integral gain 85 (K_{I}). An adder 89 adds the difference calculation value multiplied by the proportional gain 87 and the integral value multiplied by the integral gain 85 to calculate the second d-axis magnetic flux command value φd**.

As illustrated in the lower diagram of FIG. 2, in the PI controller which calculates the second q-axis magnetic flux command value φq**, the adder-subtractor 91 calculates a difference (φq*−φqc) between the first q-axis magnetic flux command value φq* and the q-axis magnetic flux estimation value φqc, and multiplies the difference calculation value by a proportional gain 97 (K_{P}). In addition, the difference calculation value is integrated by an integrator 93, and the integral value is multiplied by an integral gain 95 (KI). An adder 99 adds the difference calculation value multiplied by a proportional gain 97 and the integral value multiplied by the integral gain 95 to calculate the second d-axis magnetic flux command value φq**.

### [Voltage Vector Calculation]

A voltage vector calculation unit 19 illustrated in FIG. 1 generates a voltage command value by an inverse model of a motor model.

The inverse model of the motor model is expressed by, for example, a voltage equation as in Expression (1), where the d-axis magnetic flux and the q-axis magnetic flux of the motor are φd and φq, respectively, the d-axis voltage and the q-axis voltage of the motor are Vd and Vq, respectively, and a motor speed is ω₁.

$$\begin{matrix}[ Mathematical Formula 1 ] & \\ [ \begin{matrix}{V}_{d} \\ {V}_{q}\end{matrix} ] = [ \begin{matrix}\frac{R}{{L}_{d}} & 0 \\ 0 & \frac{R}{{L}_{q}}\end{matrix} ] [ \text{?} ] + \text{?} [ \begin{matrix}{ϕ}_{d} \\ {ϕ}_{q}\end{matrix} ] + {ω}_{1} [ \begin{matrix}0 & - 1 \\ 1 & 0\end{matrix} ] [ \begin{matrix}{ϕ}_{d} \\ {ϕ}_{q}\end{matrix} ] \text{?} & ( 1 )\end{matrix}$$

$$\text{?} \text{indicates text missing or illegible when filed}$$

In the present embodiment, the inverse model expressed by Expression (1) is applied, where Vd and Vd are the d-axis voltage command value Vd* and the q-axis voltage command value Vq*, respectively, φd and φq are the second d-axis magnetic flux command value φd** and the second q-axis magnetic flux command value φq**, respectively, and ω₁ is the speed information ω₁*.

Note that as will be described later, in Expression (1), magnetic saturation of the motor is considered.

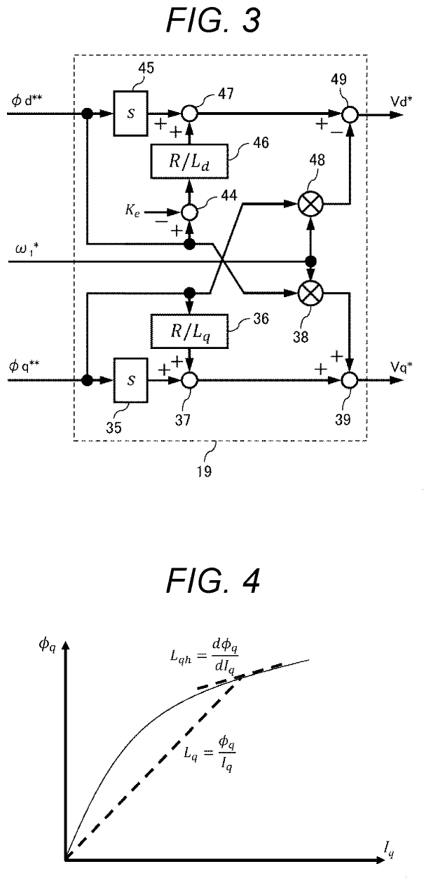

FIG. 3 illustrates a configuration of the voltage vector calculation unit 19 configured based on the inverse model expressed by Expression (1). Note that R, Ld, Lq, and Ke are a winding resistance, a d-axis inductance, a q-axis inductance, and a magnet magnetic flux in the PMSM 1, respectively.

As illustrated in FIG. 3, differentiation of φd** is calculated by a differentiator 45. In addition, a difference (φd**−Ke) between φd** and Ke is calculated by an adder-subtractor 44, and this difference calculation value is multiplied by R/Ld (46). The differential calculation value by the differentiator 45 and the difference calculation value multiplied by the gain R/Ld (46) are added by an adder 47. In addition, ω₁* and φq** are multiplied by a multiplier 48. Furthermore, an adder-subtractor 49 calculates a difference between the addition calculation value by the adder 47 and the multiplication value by the multiplier 48 to generate Vd*.

In addition, as illustrated in FIG. 3, the differentiation of φq** is calculated by a differentiator 35. In addition, φq** is multiplied by R/Lq (36). The differential calculation value by the differentiator 35 and φq** multiplied by R/Lq (36) are added by an adder 37. In addition, ω₁* and φd** are multiplied by a multiplier 38. Furthermore, the adder 39 adds the addition calculation value by the adder 37 and the multiplication value by the multiplier 38 to generate Vq*.

As described above, the voltage vector calculation unit can be configured based on the voltage equation expressing the inverse model of the motor model.

A coordinate transformation unit 11 illustrated in FIG. 1 performs coordinate transformation on the dq-axis voltage command values Vd* and Vq* for the power converter 2 output from the voltage vector calculation unit 19, by using the magnetic pole position information θ* detected by the magnetic pole position detector 4, thereby generating and outputting three-phase voltage command values Vu*, Vv*, and Vw* for the power converter 2.

A DC voltage detector 6 detects the voltage of the DC voltage source 9 and outputs DC voltage information Vdc.

A PWM controller 12 receives the three-phase voltage command values Vu*, Vv*, and Vw* from the voltage vector calculation unit 19 and receives the DC voltage information Vdc from the DC voltage detector 6, and, based on the three-phase voltage command values and the DC voltage information, generates a gate signal to be provided to the power converter 2 by pulse width modulation and outputs the gate signal. For example, the PWM controller 12 generates a gate signal by pulse width modulation using a triangular wave as a carrier signal and using a three-phase voltage command value as a modulation wave.

### [Means for Generating Voltage Command Reception]

Hereinafter, a means for generating a voltage command value in consideration of the magnetic saturation of the PMSM 1 used in the voltage vector calculation unit 19 of the present embodiment will be described.

First, in a case where the current (dq-axis current Id, Iq) is considered as a state variable, the voltage equation is expressed as Expression (2) in consideration of the magnetic saturation.

$$\begin{matrix}[ Mathematical Formula 2 ] & \\ [ \begin{matrix}{V}_{d} \\ {V}_{q}\end{matrix} ] = R [ \begin{matrix}{I}_{d} \\ {I}_{q}\end{matrix} ] + [ \begin{matrix}{L}_{dh} & {L}_{qdh} \\ {L}_{dqh} & {L}_{qh}\end{matrix} ] S [ \begin{matrix}{I}_{d} \\ {I}_{q}\end{matrix} ] + {ω}_{1} [ \begin{matrix}- {L}_{dq} & - {L}_{q} \\ {L}_{d} & {L}_{qd}\end{matrix} ] [ \begin{matrix}{I}_{d} \\ {I}_{q}\end{matrix} ] + {ω}_{1} [ \begin{matrix}0 \\ {K}_{e}\end{matrix} ] & ( 2 )\end{matrix}$$

Here, Ldh, Lqh, Ldqh, and Lqdh represent dynamic inductances, and Ld, Lq, Ldq, and Lqd represent static inductances. These inductances will be described with reference to FIG. 4.

FIG. 4 illustrates an example of a relationship between a magnetic flux and a current. Note that a vertical axis and a horizontal axis respectively represent the magnetic flux and the current, and a solid line q in the relationship diagram indicates an example of the relationship between the magnetic flux and the current.

As illustrated in FIG. 4, due to the influence of the magnetic saturation, the degree of increase in the q-axis magnetic flux (qq) becomes gentler as the q-axis current (Iq) increases. For this reason, as the inductance, the dynamic inductance and the static inductance are defined as follows. The dynamic inductance Lqh is an inclination (dφq/dt) of a tangent line (a broken line in the drawing) at a certain operating point (Iq, φq). In addition, the static inductance Lq is an inclination (φq/Iq) of a straight line (a broken line in the drawing) connecting a point at which the q-axis current (Iq) is 0 and the operating point.

Note that although not illustrated, the relationship between the d-axis magnetic flux and the d-axis current, the dynamic inductance Ldh, and the static inductance Ld are similar to those in FIG. 4.

In Expression (2), a coefficient (matrix) in a current derivative term (a second term on a right side) is the dynamic inductance, and a coefficient (matrix) in an induced voltage term (a third term on a right side) is the static inductance.

In addition, in a case where magnetic saturation is remarkable, mutual interference between control axes, that is, between dq axes occurs. Such mutual interference is expressed by the dynamic inductances Ldqh and Lqdh in the coefficient (matrix) of the current derivative term and the static inductances Ldq and Lqd in the coefficient (matrix) of the induced voltage term.

In a case where the PMSM 1 is controlled based on Expression (2), that is, in consideration of magnetic saturation using a current as a state variable, eight types of inductances (Ldh, Lqh, Ldqh, Lqdh, Ld, Lq, Ldq, Lqd) as described above are used. Therefore, in this case, the synchronous machine control device includes eight pieces of table data or functions (such as an approximate expression) representing correspondence between each inductance value and the current value (d-axis current value and q-axis current value).

Note that in consideration of the temperature dependency of the inductances, each of the table data or the mathematical expressions (such as an approximate expression) is table data or a function of three variables with the d-axis current value, the q-axis current value, and the temperature as variables.

Furthermore, since the magnet magnetic flux Ke in Expression (2) has dependency on the q-axis current Iq and the temperature T, the synchronous machine control device includes one table data or function (such as an approximate expression) of two variables with Iq and T as variables, representing a relationship between the two variables and Ke.

As described above, in a case where the PMSM 1 is controlled in consideration of the magnetic saturation using the current as the state variable, the synchronous machine control device includes a plurality of pieces of multivariable table data or multivariable functions.

In this regard, as described below, in the present embodiment, by setting the magnetic flux as a state variable as in the inverse model of the motor model expressed by above Expression (1), the total number (nine in the case of setting the current as the state variable as described above) of pieces of table data or functions (such as an approximate expression) used in the synchronous machine control device is reduced also while considering the magnetic saturation.

In a case where the magnetic flux (dq-axis magnetic flux od, qq) is considered as a state variable, the voltage equation is expressed as Expression (3) in consideration of the magnetic saturation.

$$\begin{matrix}[ Mathematical Formula 3 ] & \\ [ \begin{matrix}{V}_{d} \\ {V}_{q}\end{matrix} ] = \frac{R}{{L}_{d} {L}_{q} - {L}_{dq} {L}_{qd}} [ \begin{matrix}{L}_{q} & - {L}_{qd} \\ - {L}_{dq} & {L}_{d}\end{matrix} ] {{ϕ}_{d} - {K}_{e}}_{\text{?}} + s [ \begin{matrix}{ϕ}_{d} \\ {ϕ}_{q}\end{matrix} ] + {ω}_{1} [ \begin{matrix}0 & - 1 \\ 1 & 0\end{matrix} ] [ \begin{matrix}{ϕ}_{d} \\ {ϕ}_{q}\end{matrix} ] & ( 3 )\end{matrix}$$

$$\text{?} \text{indicates text missing or illegible when filed}$$

In many high-efficiency PMSMs, such as for automobiles, a winding resistance R is sufficiently small, so that the influence of the first term of Expression (3) in motor control is relatively small. For this reason, even if Ld, Lq, and Ke are set as constant values by approximation as in Expression (1), the influence on the motor control is small. Therefore, the voltage vector calculation unit 19 according to the present embodiment generates the dq-axis voltage command value (Vd*, Vq*) according to the dq-axis magnetic flux command value (φd**, φq**), based on Expression (1) described above in which the magnetic flux is a state variable, by setting Ld, Lq, and Ke in Expression (1) as constant values.

In this case, a synchronous machine controller device includes table data or a function (such as an approximate expression) representing a correspondence relationship between each of the d-axis magnetic flux (φd) and the q-axis magnetic flux (φq) and the current (d-axis current Id, q-axis current Iq). Therefore, the synchronous machine control device includes a total of two pieces of table data or functions.

By setting the magnetic flux to a state variable in this manner, the number of pieces of table data or functions used for motor control is reduced. As a result, since the control system is simplified while the considering magnetic saturation, the calculation load of the synchronous machine control device can be reduced, and a parameter identification time can be shortened.

In the present embodiment, the dq-axis voltage command values Vd* and Vq* are generated based on the second dq-axis magnetic flux command values φd** and φq** generated by the second dq-axis magnetic flux command calculation unit 25 by using the inverse model of the motor model. For this reason, also in a high-speed region, the d-axis magnetic flux estimation value φdc and the q-axis magnetic flux estimation value φqc can be accurately matched with the second d-axis magnetic flux command value φd** and the second q-axis magnetic flux command value φq**, respectively. Therefore, according to the synchronous machine control device of the present embodiment, it is possible to control the high-speed rotation of the PMSM 1.

In addition, in the present embodiment, the influence of the temperature dependence of the magnetic flux is alleviated by the PI controller or the I controller included in the second dq-axis magnetic flux command calculation unit 25. For this reason, the table data or the function used for the calculation of the magnetic flux (φd, φq) may be table data or a function (such as approximate expression) in which a temperature is not included as a variable and only a current is used as a variable. As a result, the calculation load of the synchronous machine control device can be reduced, and the parameter identification time can be shortened.

In addition, by using the same table data or function in the first dq-axis magnetic flux command calculation unit 21 and the dq-axis magnetic flux estimation unit 23, Idc and Iqc are controlled to match with Id* and Iq*, respectively, through magnetic flux. In this case, a current control system is substantially configured.

In addition, by using both Idc, Iqc and Id*, Iq* for inputs to the first dq-axis magnetic flux command calculation unit 21 and the dq-axis magnetic flux estimation unit 23, it is possible to perform control in consideration of mutual interference between axes. In this case, each of the first dq-axis magnetic flux command calculation unit 21 and the dq-axis magnetic flux estimation unit 23 uses table data or a function representing a correspondence relationship between the dq-axis magnetic flux command value (φd*, φq*) and the dq-axis current command value (Id*, Iq*), and table data or function representing a correspondence relationship between the dq-axis magnetic flux estimation value (φdc, φqc) and the dq-axis current detection value (Idc, Iqc).

Note that since the synchronous machine control device of the present embodiment substantially considers the dynamic inductance and the static inductance of the motor, the synchronous machine control device is suitable for application to an electric vehicle such as an electric car in which a PMSM having a large influence of magnetic saturation is used and an accurate torque response is required.

Note that the above-described lookup table, table data, and function (approximate expression), which are information indicating the correspondence relationship between the magnetic flux and the current in the PMSM 1, can be set based on actual measurement, magnetic field analysis, or the like.

### [Initialization of Integrator]

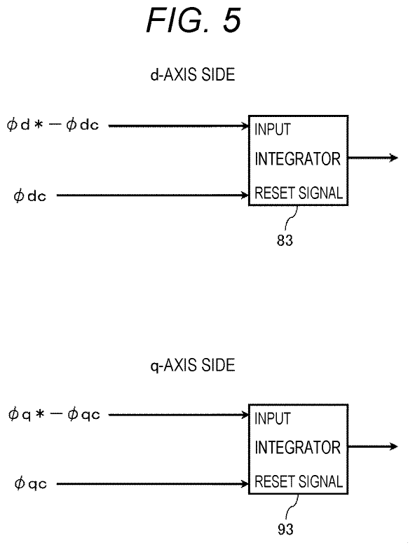

Next, initialization of an integrator according to the present embodiment will be described with reference to FIGS. 5 to 8.

When the power converter 2 is switched from a three-phase open mode or a three-phase short-circuit mode to a torque mode (PWM mode), it is necessary to set initial values of the integrator 83 and the integrator 93. Here, in a case where the initial value is incorrect, a difference may occur between the output voltage of the power converter 2 and the voltage of the PMSM 1 at the time of switching to the PWM mode, and an overcurrent, a torque fluctuation, or the like may occur.

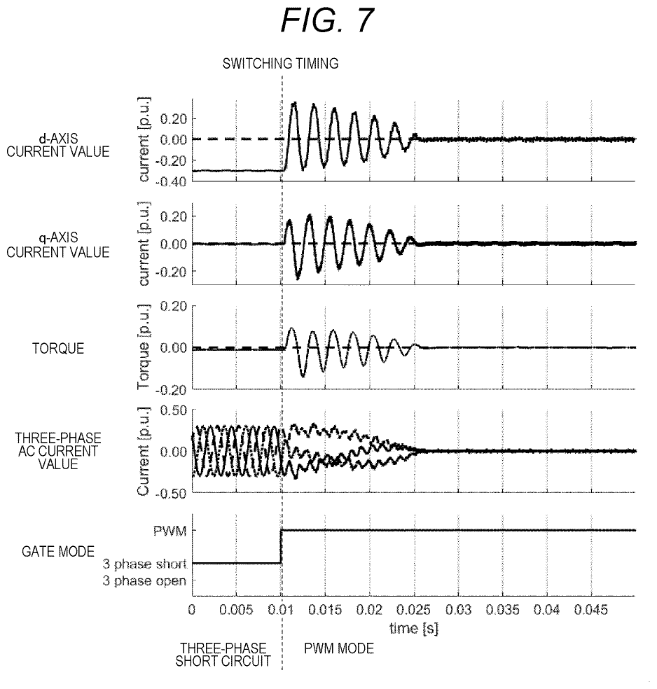

FIG. 7 is a diagram illustrating a current waveform at the time of switching from the three-phase short circuit to the PWM mode in a conventional control. Waveforms of a d-axis current, a q-axis current, a torque, and a three-phase AC current and a gate mode switching signal in a case where the integrator 83 on a d-axis side is initialized to the magnet magnetic flux Ke and the integrator 93 on a q-axis side is initialized to 0 are illustrated. A dotted line in FIG. 7 indicates a switching timing from the three-phase short circuit to the PWM mode of the power converter 2.

As illustrated in FIG. 7, it can be seen that fluctuations of the d-axis current value and the q-axis current value increase after the switching timing. This is because there is a difference between the output voltage of the power converter 2 and the voltage of the motor. Therefore, in order to prevent an overcurrent, it is necessary to set appropriate initial values for the integrators 83 and 93 at the switching timing.

FIG. 5 is a block diagram of an integrator according to the present embodiment. As illustrated in FIG. 5, the integrator 83 receives the gate mode switching signal when the driving state (gate mode) of the power converter 2 is switched from an upper controller (not illustrated) or the like. In this case, the d-axis magnetic flux estimation value φdc is used as an initial value for the integrator 83 on the d-axis side. Similarly, the q-axis magnetic flux estimation value φqc is used as an initial value for the integrator 93 on the q-axis side. Alternatively, a value obtained by performing low-pass filtering processing on the d-axis magnetic flux estimation value φdc and the q-axis magnetic flux estimation value φqc may be used as the initial value.

As in the present embodiment, in the vector control using the magnetic flux as a control amount, the integral value on the d-axis side matches with the d-axis magnetic flux estimation value φdc in a steady state. In addition, the integral value on the q-axis side matches with the q-axis magnetic flux estimation value φqc. Therefore, by initializing the integrator 83 on the d-axis side with the d-axis magnetic flux estimation value φdc and initializing the integrator 93 on the q-axis side with the q-axis magnetic flux estimation value φqc, the voltage of the PMSM 1 and the voltage of the power converter 2 match, so that it is possible to suppress a change in current at the time of switching.

Specifically, in a case where the power converter 2 is in the three-phase short circuit, the voltage becomes 0 V, and a current flows into the PMSM 1 such that the voltage becomes 0 V. Therefore, in a case where the power converter 2 transitions from the three-phase short circuit to the PWM mode, it is sufficient if a voltage that allows a current flowing during the three-phase short circuit to flow is output. That is, by initializing the integrator 83 on the d-axis side with the d-axis magnetic flux estimation value φdc and initializing the integrator 93 on the q-axis side with the q-axis magnetic flux estimation value φqc, the voltage of the PMSM 1 and the voltage of the power converter 2 match, so that it is possible to suppress a change in current at the time of switching.

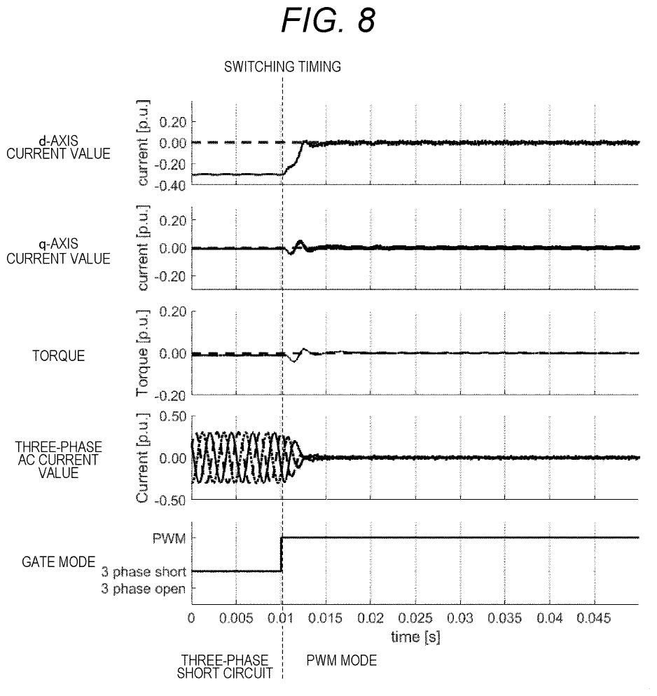

FIG. 8 is a diagram illustrating a change in current at the time of switching from the three-phase short circuit to the PWM mode in the control according to the present embodiment. The waveforms of the d axis current, the q axis current, the torque, and the three-phase AC current and the gate mode switching signal in a case where the integrator 83 on the d-axis side is initialized to the d-axis magnetic flux estimation value φdc, and the integrator 93 on the q-axis side is initialized to the q-axis magnetic flux estimation value φqc are illustrated. As illustrated in FIG. 8, the control device according to the present embodiment suppresses changes in the d-axis current and the q-axis current after the switching of the power converter 2. As a result, it is possible to suppress the occurrence of overcurrent.

In addition, in a case where the power converter 2 is in the three-phase open state, the current in the power converter 2 becomes 0 A (id=iq=0 A), and only the induced voltage (Vq=ωKe) is output from the motor. Therefore, in a case where the power converter 2 transitions from the three-phase open state to the PWM mode, it is sufficient if the power converter 2 outputs a voltage that cancels the induced voltage of the PMSM 1. That is, the integrator 83 on the d-axis side is initialized to the d-axis magnetic flux estimation value φdc, and the integrator 93 on the q-axis side is initialized to the q-axis magnetic flux estimation value φqc=0. As a result, the occurrence of overcurrent can be suppressed even in a case where the three-phase short circuit transitions to the PWM mode.

### Modification

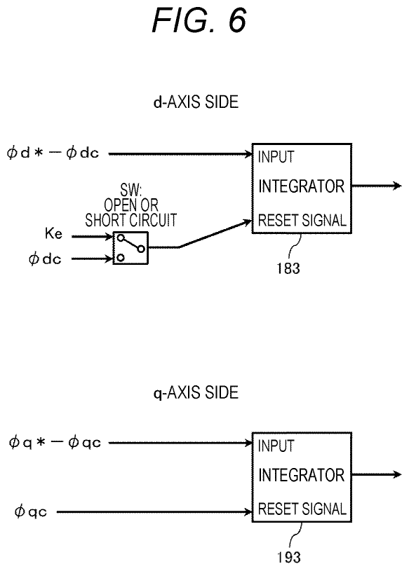

Next, a modification of the present embodiment will be described with reference to FIG. 6. FIG. 6 is a diagram illustrating an integrator according to the modification of the present embodiment.

As illustrated in the upper diagram of FIG. 6, a configuration is made such that a value to be initialized of the integrator 183 on the d-axis side differs depending on the state before the switching of the drive mode of the power converter 2. As a result, the integrator 183 can be initialized to an appropriate value according to the state before the switching of the drive mode of the power converter 2.

For example, in the configuration of FIG. 6, in a case where the driving state of the power converter 2 before switching is the three-phase open mode, the initialization is performed with the magnet magnetic flux Ke in consideration of a rotor temperature, and in a case where the driving state of the power converter 2 before switching is the three-phase short circuit, the initialization is performed with the d-axis magnetic flux estimation value φdc. Since the d-axis magnetic flux estimation value φdc changes depending on the rotor temperature of the PMSM 1, more accurate control can be performed by using the magnet magnetic flux Ke in consideration of the rotor temperature. The reason for considering the rotor temperature only for the three-phase open mode is to actively use the three-phase open mode during operation for loss reduction in automobiles or the like. Therefore, it is desirable to suppress a torque fluctuation as much as possible at the time of switching between the three-phase open mode and the PWM mode, and to prevent deterioration of ride comfort or the like. On the other hand, it is assumed that the three-phase short circuit is performed under special conditions such as a failure of the power converter 2. Therefore, it is sufficient that an overcurrent can be suppressed in switching between the three-phase short circuit and the PWM mode. As a result, it is possible to save labor of adapting the PMSM 1.

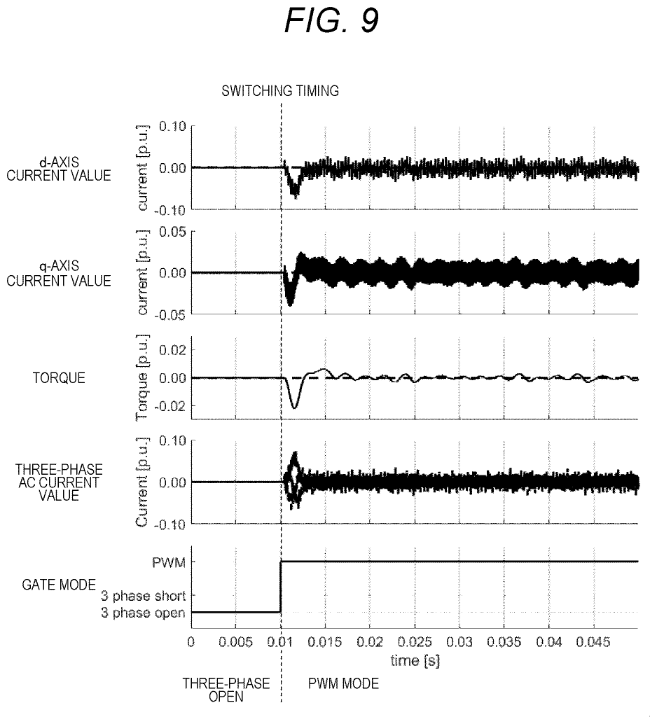

FIG. 9 is a diagram illustrating a current waveform at the time of switching from the three-phase open mode to the PWM mode in the conventional control. The temporal changes in the d-axis current, the q-axis current, the torque, and the three-phase AC current and the gate mode switching signal in a case where the integrator 83 on the d-axis side is initialized to the magnet magnetic flux Ke without considering the rotor temperature, and the integrator 93 on the q-axis side is initialized to 0 are illustrated. A dotted line in FIG. 9 indicates a switching timing from the three-phase open mode to the PWM mode of the power converter 2.

As illustrated in FIG. 9, it can be seen that fluctuations of the d-axis current value and the q-axis current value increase after the switching timing. This is because the magnet magnetic flux of the PMSM 1 changes depending on the rotor temperature, and thus, there is a difference from the magnet magnetic flux Ke set as the initial value. As a result, a torque fluctuation may occur due to a difference between the output voltage of the power converter 2 and the voltage of the PMSM 1. Therefore, in order to prevent the torque fluctuation, it is necessary to set appropriate initial values for the integrators 83 and 93 at the switching timing.

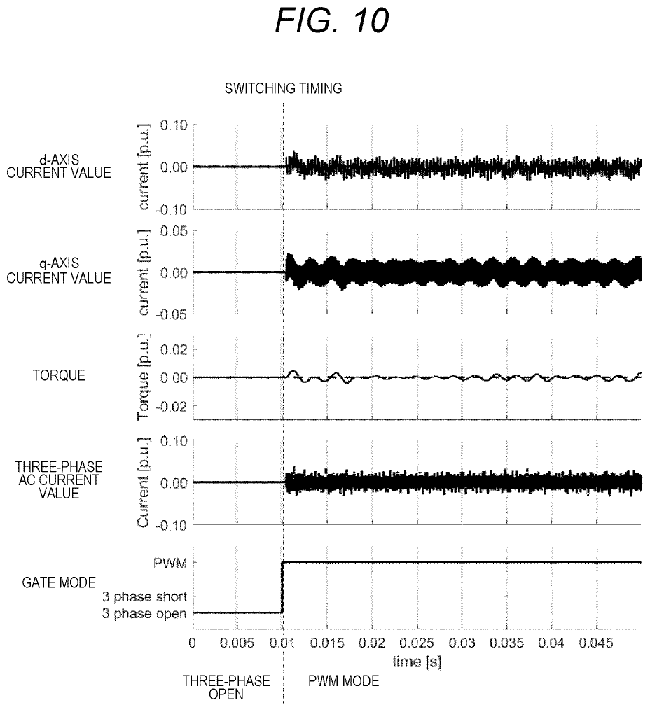

FIG. 10 is a diagram illustrating a current waveform at the time of switching from the three-phase open mode to the PWM mode in the control according to the modification of the present embodiment. The temporal changes in the d-axis current, the q-axis current, the torque, and the three-phase AC current and the gate mode switching signal in a case where the integrator 83 on the d-axis side is initialized to the magnet magnetic flux Ke in consideration of the rotor temperature, and the integrator 93 on the q-axis side is initialized to the q-axis magnetic flux estimation value φqc (═O) are illustrated. As illustrated in FIG. 10, the control device according to the present embodiment suppresses changes in the d-axis current and the q-axis current after the switching of the power converter 2. As a result, it is possible to suppress the occurrence of deterioration in ride comfort or the like due to a rapid torque fluctuation.

Note that the dq-axis magnetic flux estimation unit 23 may be configured to estimate the d-axis and q-axis magnetic flux values of the PMSM 1, based on a three-dimensional table in which the rotor temperature of the PMSM 1 is taken into consideration. As a result, although the motor adaptation work increases, since the rotor temperature can be considered, it is possible to more accurately prevent an overcurrent, a torque fluctuation, or the like due to a change in the driving state of the power converter 2.

Furthermore, a configuration may be made such that in a case where the rotor temperature information cannot be acquired, the integrator is initialized to the rotor temperature as a predetermined value. As a result, even in a case where the rotor temperature cannot be acquired, it is possible to prevent an overcurrent, a torque fluctuation, or the like due to a change in the driving state of the power converter 2.

The present embodiment described above is summarized as follows.

A synchronous machine control device which controls a power converter which supplies power to a synchronous machine, the synchronous machine control device comprising: a first magnetic flux command calculation unit which calculates a first magnetic flux command value from a current command value of the synchronous machine; a magnetic flux estimation unit that estimates magnetic flux values of a d axis and a q axis of the synchronous machine from a current detection value of the synchronous machine; a voltage calculation unit which generates a voltage command value of the power converter such that the first magnetic flux command value and the magnetic flux value match; and a second magnetic flux command calculation unit which uses an integrator to calculate each second magnetic flux command value on a d-axis side and a q-axis side such that the first magnetic flux command value and the magnetic flux value match, in which when a driving state of the power converter is switched, the integrator on the d-axis side is initialized to a d-axis magnetic flux value, and the integrator on the q-axis side is initialized to a q-axis magnetic flux value. As a result, an overcurrent or the like due to a change in the driving state of the power converter can be prevented.

Furthermore, the integration controller may have a configuration in which, when the driving state of the power converter is switched, a value to be initialized differs depending on the driving state before switching. As a result, since the integrator can be initialized to an appropriate value, it is possible to more accurately prevent a torque fluctuation or the like due to a change in the driving state of the power converter.

Furthermore, a configuration may be made such that when the driving state before the switching is the three-phase open, the d-axis side is initialized to a value obtained based on the temperature of the rotor of the synchronous machine. As a result, it is possible to prevent deterioration of ride comfort or the like due to a rapid torque fluctuation when the power conversion device is switched from the three-phase open mode to the PWM mode.

Furthermore, when the driving state before the switching is a three-phase short circuit, the d-axis side may be initialized to a d-axis magnetic flux value, and the q-axis side may be initialized to a q-axis magnetic flux value, and when the driving state before the switching is the three-phase open, the d-axis side may be initialized to a magnet magnetic flux Ke in consideration of a temperature of a rotor of the synchronous machine, and the q-axis side may be initialized to a q-axis magnetic flux value. As a result, it is possible to more accurately prevent an overcurrent or the like due to a change in the driving state of the power converter.

Furthermore, the magnetic flux estimation unit may be configured to estimate d-axis and q-axis magnetic flux values of the synchronous machine, based on a three-dimensional table in which a rotor temperature of the synchronous machine is taken into consideration. As a result, since the rotor temperature can be considered, it is possible to more accurately prevent an overcurrent, a torque fluctuation, or the like due to a change in the driving state of the power converter.

Furthermore, a configuration may be made such that in a case where the rotor temperature information cannot be acquired, the integrator is initialized to the rotor temperature as a predetermined value. As a result, even in a case where the rotor temperature cannot be acquired, it is possible to prevent an overcurrent, a torque fluctuation, or the like due to a change in the driving state of the power converter.

Note that the present invention is not limited to the above-described embodiment, and includes various modifications. For example, the above-described embodiment has been described in detail for easy understanding of the present invention, and is not necessarily limited to those having all the described configurations. In addition, it is possible to add, delete, and replace other configurations for a part of the configuration of each embodiment.

For example, the synchronous machine to be controlled is not limited to the PMSM, and may be a synchronous reluctance motor, a permanent magnet synchronous generator, a wound field synchronous motor, a wound field synchronous generator, or the like.

In addition, the PMSM may be either an embedded magnet type or a surface magnet type, or may be either an outer rotation type or an inner rotation type.

In addition, the semiconductor switching element constituting the inverter main circuit is not limited to the IGBT, and may be a metal oxide semiconductor field effect transistor (MOSFET) or the like.

In addition, the synchronous machine control device according to each embodiment described above can be applied as this control device in various synchronous machine drive systems including a synchronous machine, a power converter which drives the synchronous machine, and a control device which controls the power converter.

### REFERENCE SIGNS LIST

1 PMSM
2 power converter
3 phase current detector
4 magnetic pole position detector
5 frequency calculation unit
6 DC voltage detector
7 coordinate transformation unit
10 voltage vector adding unit
11 coordinate transformation unit
15 dq-axis voltage command calculation unit
19 voltage vector calculation unit
21 first dq-axis magnetic flux command calculation unit
23 dq-axis magnetic flux estimation unit
25 second dq-axis magnetic flux command calculation unit
35 differentiator
37 adder
38 multiplier
39 adder
44 adder-subtractor
45 differentiator
47 adder
48 multiplier
49 adder-subtractor
55 multiplier
57 multiplier
81 adder-subtractor
83 integrator
85 integral gain
87 proportional gain
89 adder
91 adder-subtractor
93 integrator
95 integral gain
97 proportional gain
98 adder
99 adder
183 integrator
193 integrator

1. A synchronous machine control device which controls a power converter which supplies power to a synchronous machine, the synchronous machine control device comprising:
a first magnetic flux command calculation unit which calculates a first magnetic flux command value from a current command value of the synchronous machine;
a magnetic flux estimation unit that estimates magnetic flux values of a d axis and a q axis of the synchronous machine from a current detection value of the synchronous machine;
a voltage calculation unit which generates a voltage command value of the power converter such that the first magnetic flux command value and the magnetic flux value match; and
a second magnetic flux command calculation unit which uses an integration controller to calculate each second magnetic flux command value on a d-axis side and a q-axis side such that the first magnetic flux command value and the magnetic flux value match, wherein
when a driving state of the power converter is switched,
the integration controller on the d-axis side is initialized to a d-axis magnetic flux value, and the integration controller on the q-axis side is initialized to a q-axis magnetic flux value.

2. The synchronous machine control device according to claim 1, wherein
in the integration controller, when the driving state of the power converter is switched, a value to be initialized differs depending on the driving state before switching.

3. The synchronous machine control device according to claim 2, wherein
when the driving state before the switching is a three-phase open, the d-axis side is initialized to a magnet magnetic flux.

4. The synchronous machine control device according to claim 2, wherein
when the driving state before the switching is a three-phase short circuit, the d-axis side is initialized to a d-axis magnetic flux value, and the q-axis side is initialized to a q-axis magnetic flux value, and
when the driving state before the switching is a three-phase open, the d-axis side is initialized to a magnet magnetic flux in consideration of a temperature of a rotor of the synchronous machine, and the q-axis side is initialized to a q-axis magnetic flux value.

5. The synchronous machine control device according to claim 1, wherein
based on a three-dimensional table in which a rotor temperature of the synchronous machine is taken into consideration, the magnetic flux estimation unit
estimates d-axis and q-axis magnetic flux values of the synchronous machine.

6. The synchronous machine control device according to claim 4, wherein
in a case where the rotor temperature information is not able to be acquired, the integration controller is initialized to the rotor temperature as a predetermined value.
